(19) United States
(12) Patent Application Publication
(10) Pub. No.: US 2019/0284014 A1
(43) Pub. Date: Sep. 19, 2019

(54) Vehicle Cord Organizer

(71) Applicant: Taylor N. Pollock, Dyersburg, TN (US)

(72) Inventor: Taylor N. Pollock, Dyersburg, TN (US)

(21) Appl. No.: 15/919,848

(22) Filed: Mar. 13, 2018

(51) Int. Cl. B65H 75/06; H01R 13/66; B65H 75/44

(52) U.S. Cl. CPC B65H 75/06; H01R 13/665; H01R 2201/26; B65H 2701/34; B65H 75/4473

(57) ABSTRACT

The present disclosure reveals a vehicle cord organizer for use in a vehicle to aid in the managing of cords of electronic devices as the cords are connected to the power supply of the vehicle and to electronic devices. In addition to the basic design of the vehicle cord organizer, several features may also be included including an adjustable clip, used to ensure the vehicle cord organizer does not impede the air flow coming from a vent to which the vehicle cord organizer is attached, a plurality of usb ports to aid in powering the electronic devices, cord stabilizers to aid in separating cords from each other, a stabilizer bar, a rubber coating to increase friction between the cords and vehicle cord organizer to aid in separation of cords, and/or no-slip edges to aid in separation of cords.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC

Not Applicable

### DESCRIPTION

### Field of the invention

In today's modern era, people travel in vehicles including but not limited to cars, boats, and trucks with multiple electronic devices including but not limited to phones, dvd players, Ipods, Ipads, GPS units. Although these electronic devices may have battery power, these batteries loose power and need charging during operation of the electronic device. In order to recharge the electronic devices in a vehicle cords are plugged into power supplies within the vehicle, for example, what was previously known as the cigarette lighter. Because an individual may have multiple devices or multiple people may be in the vehicle, each with his or her own set of electronic devices, the result may be cords extending all over the vehicle. The vehicle cord organizer is designed to aid in the management of the cords.

### Background of the Invention

The need for a vehicle cord organizer is derived from the present situation whereby individuals have multiple battery powered mobile devices or multiple people may each have one or more electronic devices and these electronic devices require recharging. In a vehicle, that means cords run from vehicle power supplies to these electronic devices and extend through the vehicle. The vehicle cord organizer is designed to aid in the management of those cords.

### SUMMARY OF THE INVENTION

The present disclosure reveals a vehicle cord organizer for use in a vehicle to aid in the managing of cords of electronic devices as the cords are connected to the power supply of the vehicle and to electronic devices. This vehicle cord organizer can be attached to an air vent in order to be located near a vehicle power supply source.

In addition to the basic design of the vehicle cord organizer, several features may also be included including an adjustable clip, used to ensure the vehicle cord organizer does not impede the air flow coming from a vent to which the vehicle cord organizer is attached, a plurality of usb ports to aid in powering the electronic devices, cord stabilizers to aid in separating cords from each other, a stabilizer bar, a rubber coating to increase friction between the cords and vehicle cord organizer to aid in separation of cords, and/or no-slip edges to aid in separation of cords.

### BRIEF DESCRIPTION OF THE SEVERAL VIEWS OF THE DRAWING

FIG. 1 is a view the front of the vehicle cord organizer;

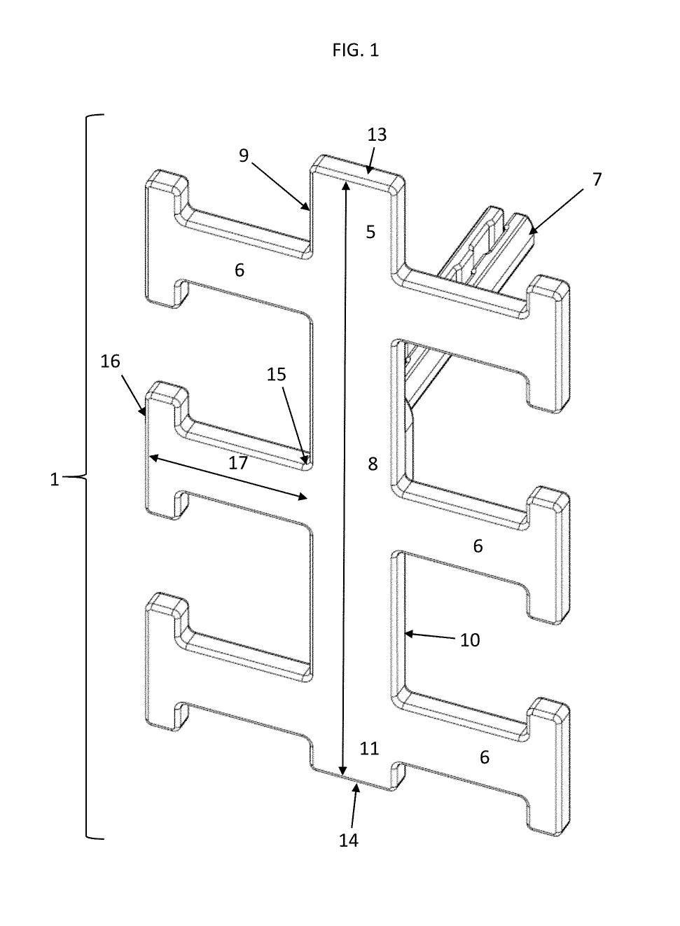

FIG. 2 is a view the back of the vehicle cord organizer including the extension;

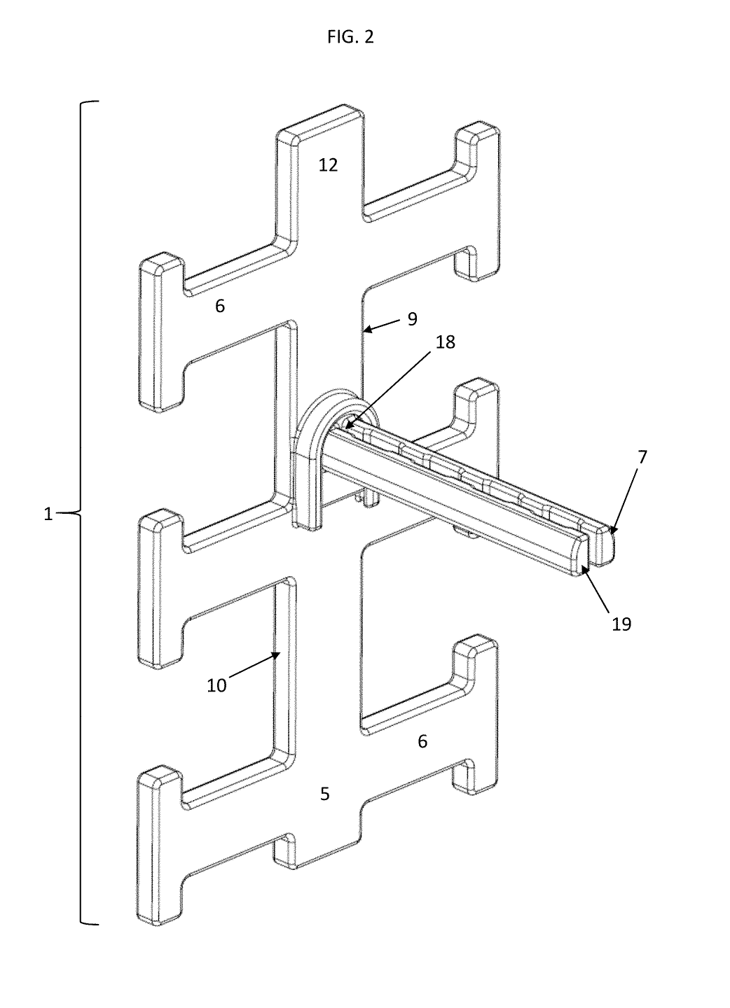

FIG. 3 is a view of the back of the vehicle cord organizer and the adjustable clip;

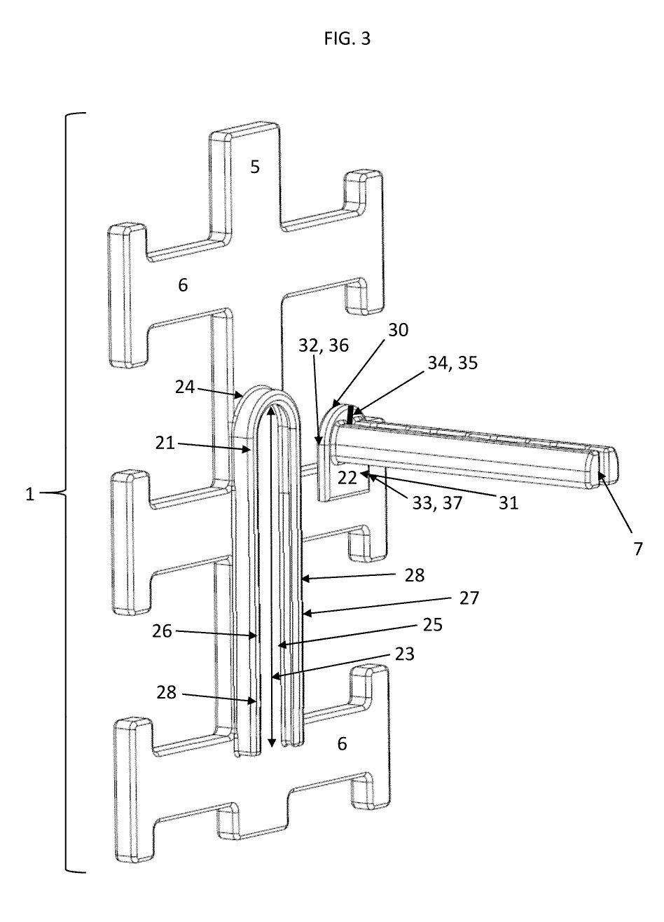

FIG. 4 is a view of the affront of the vehicle cord organizer including a plurality of cord stabilizers;

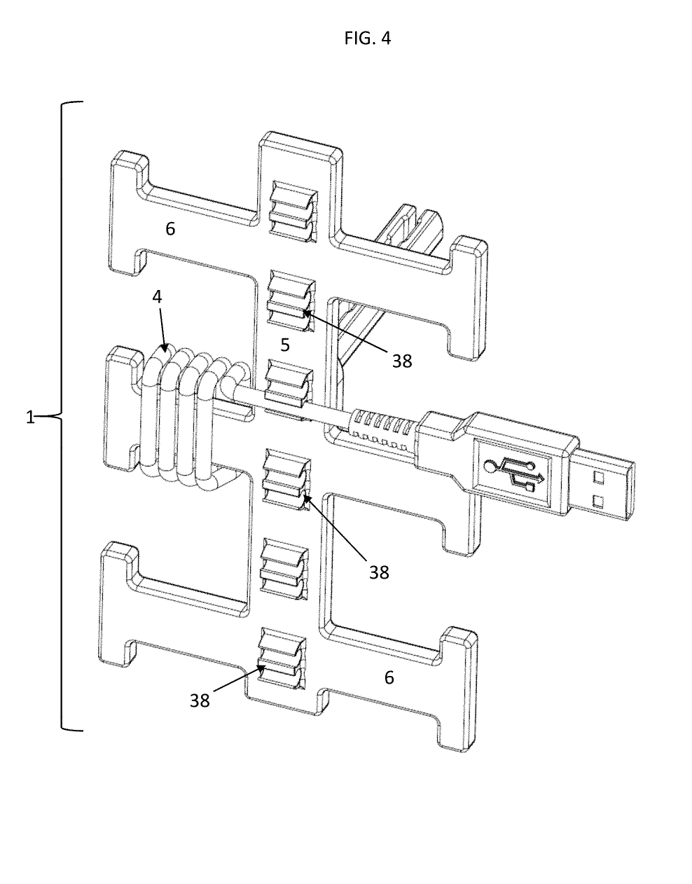

FIG. 5A is a view of the front of the vehicle cord organizer including a plurality of usb ports;

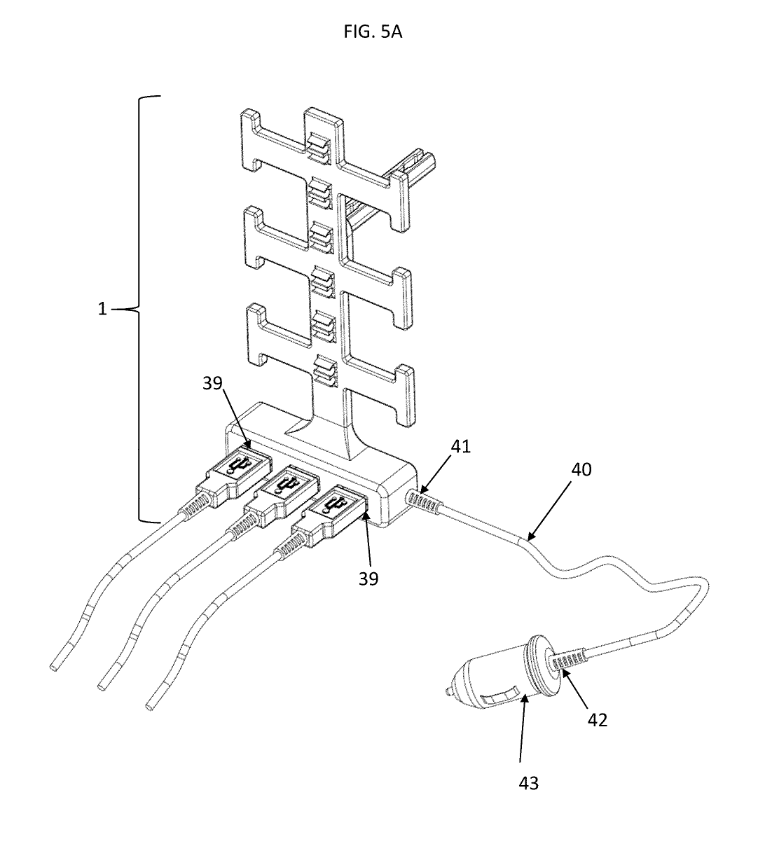

FIG. 5B is a view of the wiring associated with the plurality of usb ports of the vehicle cord organizer;

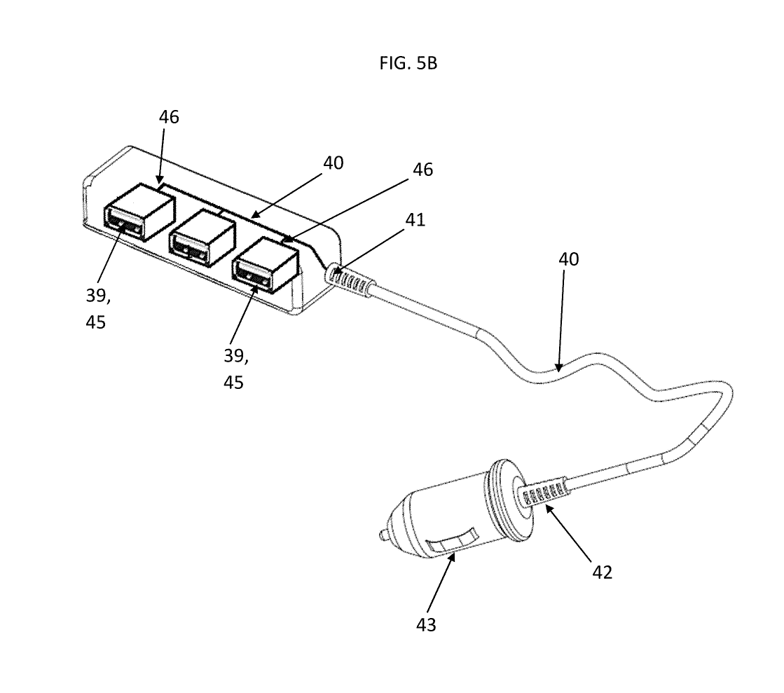

FIG. 6 is a view of the front of the vehicle cord organizer including the stabilizer bar;

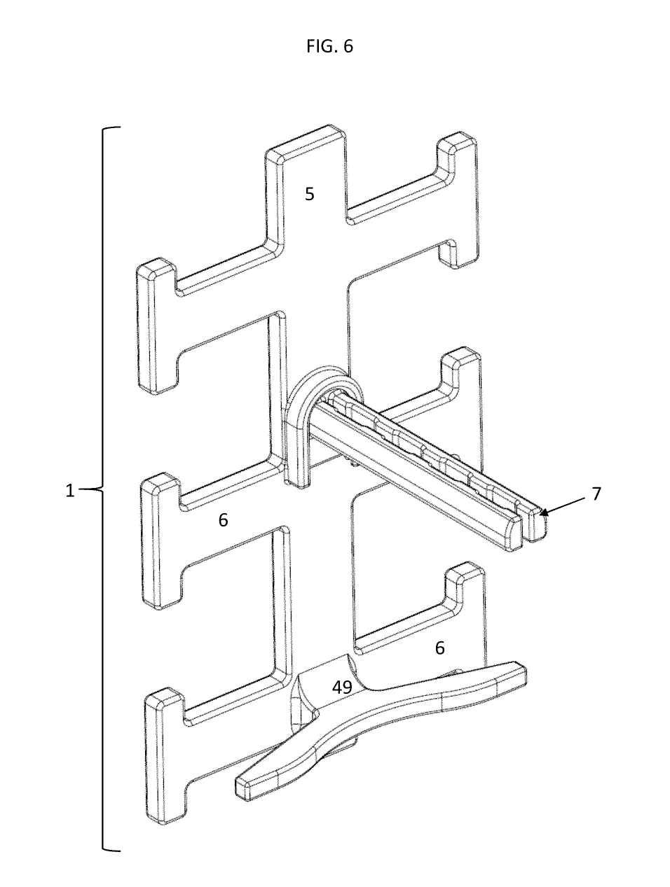

FIG. 7 is a view of the vehicle cord organizer coated with rubber;

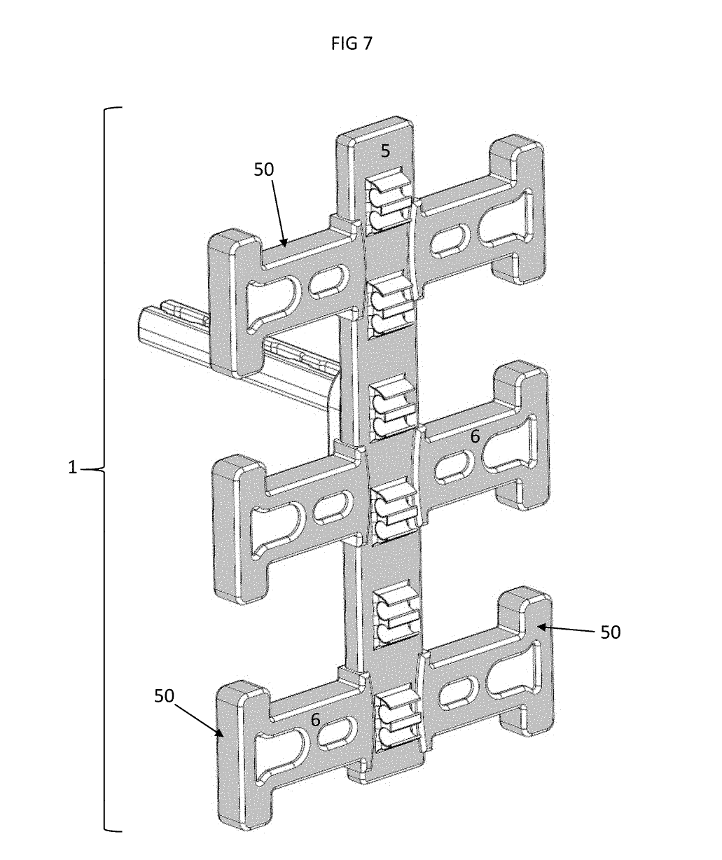

FIG. 8 is a view of the vehicle cord organizer including the no-slip edges; and

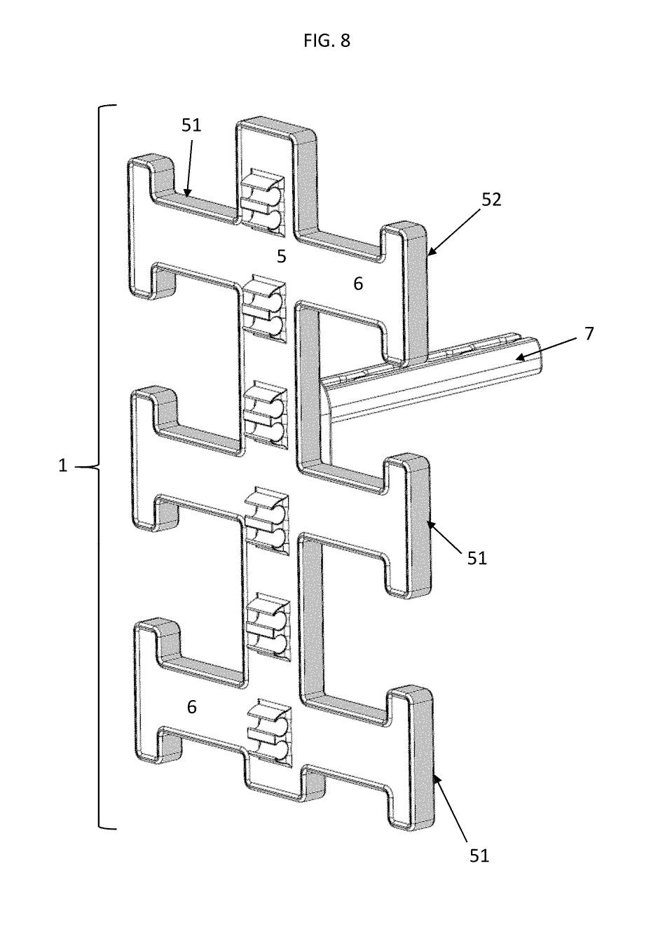

FIG. 9 is a view of the vehicle cord organizer in a vehicle and attached to a vent.

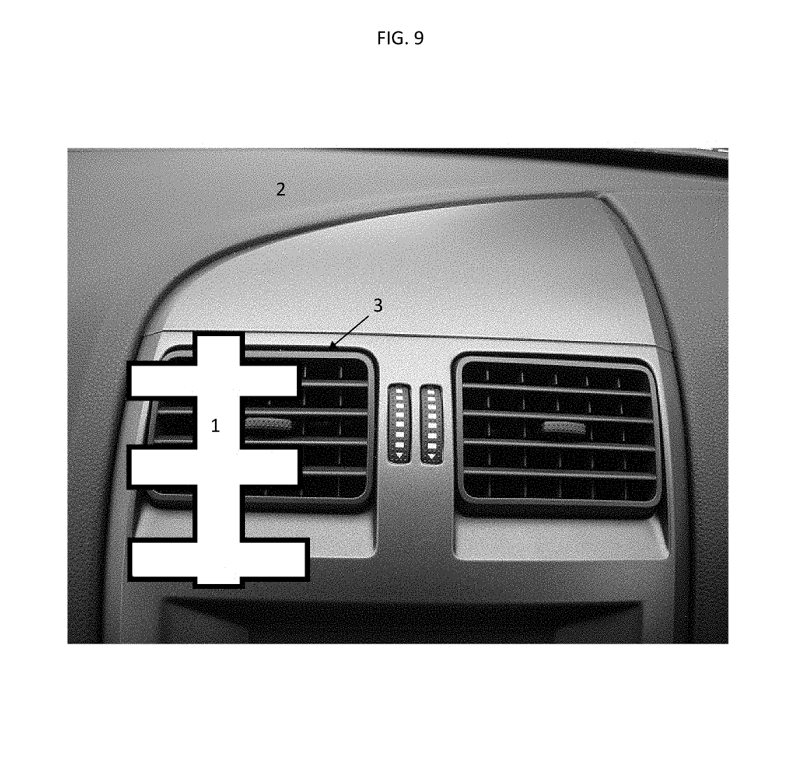

### DETAILED DESCRIPTION OF THE INVENTION

The present disclosure reveals a vehicle cord organizer 1 for use in a vehicle 2 to be hung from a vent 3 in order to aid in the managing of cords 4 of electronic devices including but not limited to dvd players, cell phones, Ipads, Ipods, and gps units, that connect the electronic devices to a power supply of the vehicle, said vehicle cord organizer 1 comprising a body 5, a plurality of arms 6, and an extension 7. The body 5 comprises a length 8, a left side 9, a right side 10, a front 11, a back 12, a top 13, and a bottom 14. Each arm 6 of the plurality of arms 6 comprises a first end 15 that is connected to the 5 body, a second end 16, and a length 17 between the first end 15 and the second end 16. There are a plurality of arms 6 that extend from the left side 9 of the body 5, such that the first end 15 of each arm 6 of the plurality of arms 6 on the left side 9 is attached to the left side 9 of the body 5 and wherein there are a plurality of arms 6 that extend from the right side 10 of the body 5, such that the first end 15 of each arm 6 of the plurality of arms 6 that is attached to the right side 10 of the body 5. The attachment between each arm 6 of the plurality of arms 6 and the body 5 may be because the vehicle cord organizer 1 is made of a single piece or an arm 6 may be attached by a method common to the industry to the body, said common method of attachment may include but not be limited by adhesive, fasteners, rivets, touch fastener, or a locking mechanism.

The extension 7 is comprised an attached end 18 and a connection end 19 such that the attached end 18 is connected to the back 12 of the body 5 and extends away from the body 5 in such a fashion to allow the connection 7 to latch onto a vent 3 of a vehicle 2. Said connection of the attachment end 18 to the body 5 may be directly one to the other or may be through an intermediary. Because of the shape of the vehicle cord organizer 1, cords 4 of electronic devices can be wrapped around the plurality of arms 6 and the body 5 of the vehicle cord organizer 1 in such a fashion to control the length of the cords 4.

In addition to the basic design of the vehicle cord organizer 1, there are several features that can be included. The first feature is an adjustable clip 20 which involves the attachment of the extension 7 to the body 5 in such a fashion so that the positioning of the extension 7 is adjustable vertically along the length 8 of the body 5 so that the vehicle cord organizer 1 does not impede airflow from the vent 3 of the vehicle 2. This adjustable clip 20 comprises a track 21 and a base 22. The track 21 comprises a front 23, a back 24, a length 25, a left edge 26, and a right edge 27. The left edge 26 and the right edge 27 of the track 21 is further comprised of at least one of a raised edge 29 or a plurality of teeth 29 that extend up along the left edge 26 and the right edge 27. The back 24 of the track 21 is attached to the back 12 of the body 5 of the vehicle cord organizer 1.

The base 22 comprises a bottom 30, a top 31, a left side 32, a right side 33, and a release mechanism 34. The bottom 30 of the base 22 is positioned so as to be against the front 23 of the track 21 such that the left side 32 of the base 22 parallels the left edge 26 of the track 21 and the right side 33 of the base 22 parallels the right edge 27 of the track 21. The release mechanism 34 comprises a lever 35, a left edge lock 36, and a right edge lock 37. The left edge lock 36 comprises at least one of a plurality of teeth or a friction pad and the right edge lock 37 comprises at least one of a plurality of teeth or a friction pad. The base 22 operates in such a fashion so that, when the lever 35 is engaged the base 22 is slide-able along the length 25 of the track 21 and when the lever 35 is released the left edge lock 36 presses against the left edge 26 of the track 21 and the right edge lock 37 presses against right edge 27 of the track 21 in order to lock the position of the base 30 in place. The attached end 18 of the extension 7 is connected to the top 31 of the base 22 and the base 22 attaches the extension 7 to the body 5 of the vehicle cord organizer 1 so that, as the base 22 is moved along the length 25 of the track 21 the position of the extension 7 is adjusted relative to the length 8 of the body 5.

The second feature of the vehicle cord organizer comprises a plurality of cord stabilizers 38, said plurality of cord stabilizers 38 being positioned along the length 8 of the front 11 of the body 5 and extending away from the body 5 to aid in separating one cord 4 that is wrapped around the vehicle cord organizer 1 from another cord 4 that is wrapped around the vehicle cord organizer 1.

The third feature of the vehicle cord organizer comprises a plurality of usb ports 39 and usb power cord 40. The usb power cord 40 comprises a first end 41 that is attached to the body 5 of the vehicle cord organizer 1 and a second end 42 to which is attached a DC connector 43 capable of connecting to power ports of the vehicle 2. Each usb port 39 of the plurality of usb ports 39 comprising a receptacle 45 and a cable 46. The cable 46 of each usb port 39 of the plurality of usb ports 39 comprises a first end 47 that is attached to the receptacle 45 and a second end 48 that is attached to the first end 41 of the usb power cord 40. Electricity is capable of traveling from the power ports of the vehicle 1, through the DC connector 43, through the usb power cord 40, to the cables 46 of each of the plurality of usb ports 39, and to the receptacles 45 of each of the plurality of usb ports 39 in order to supply power to the cords 4 wrapped around the vehicle cord organizer 1.

The fourth feature of the vehicle cord organizer 1 comprises a stabilizer bar 49 located at the bottom 14 of the body 5 of the vehicle cord organizer 1, wherein said stabilizer bar 49 extends left and right of the body 5.

The fifth feature of the vehicle cord organizer 1 comprises an apparatus for increasing the friction between the cord 4 to be wrapped around the vehicle cord organizer 1 and the vehicle cord organizer 1 itself. This feature is comprised of at least one of a rubber coating 50 to increase the friction between the cords 4 wrapped around the vehicle cord organizer 1 and the vehicle cord organizer 4 and/or no-slip edges 51 such that the body 5 of the vehicle cord organizer 1 and each arm 6 of the plurality of arms 6 further comprise edges 52 and those edges 52 are no-slip edges 51.

Each of the features identified may be included with the basic design of the vehicle cord organizer 1 and with any of the other features.

What is claimed:

1. a vehicle cord organizer for use in a vehicle to be hung from a vent in order to aid in the managing of wires of electronic devices that connect the electronic devices to a power supply of the vehicle, said vehicle cord organizer comprising:
a body, a plurality of arms, and an extension;
the body comprising a length, a left side, a right side, a front, a back, a top and a bottom;
the plurality of arms wherein each arm of the plurality of arms comprises a first end that is connected to the central body, a second end, and a length between the first end and the second end;
wherein the plurality of arms extend from the left side of the body, such that the first end is attached to the left side of the body and wherein the plurality of arms extend from the right side of the body, such that the first end is attached to the right side of the body;
the extension comprising an attached end and a connection end such that the attached end is attached to the back of the body and extends away from the body in such a fashion to allow the connection to latch onto a vent of a vehicle; and
wherein wires of electronic devices can be wrapped around the plurality of arms and body of the vehicle cord organizer in such a fashion to control the length of the wires.

2. The vehicle cord organizer of claim 1 wherein the vehicle cord organizer further comprises an adjustable clip that allows the extension to be moved along the length of the body so that the vehicle cord organizer does not impede the flow of air from the vent to which the vehicle cord organizer is connected, said adjustable clip comprising a track and a base;
said track comprising a front, a back, a length, a left edge and a right edge;
the left edge and the right edge or the track being further comprised of at least one of a raised edge or a plurality of teeth;
the back of the track being attached to the back of the body;
the base comprising a bottom, a top, a left side, a right side, and a release mechanism;
the bottom of the base being positioned so as to be against the front of the track such that the left side of the base parallels the left side of the track and the right side of the base parallels the right side of the track;
the release mechanism comprising a lever, a left edge lock and a right edge lock;
the left edge lock comprising at least one of a plurality of teeth or a friction pad and the right edge lock comprising at least one of a plurality of teeth or a friction pad;
wherein the base operates in such a fashion so that, when the lever is engaged the base is slide-able along the length of the track and when the lever is released the left edge lock presses against the left edge of the track and the right edge lock presses against right edge of the track in order to lock the position of the base in place;
wherein the attached end of the extension is connected to the top of the base and the base attaches the extension to the body of the vehicle cord organizer so that, as the base is moved along the length of the track the position of the extension is adjusted relative to the length of the body.

3. The vehicle cord organizer of claim 1 wherein the vehicle cord organizer further comprises a plurality of cord stabilizers, said plurality of cord stabilizers being positioned along the length of the front of the body and extending away from the body to aid in separating one cord that is wrapped around the vehicle cord organizer from another cord that is wrapped around the vehicle cord organizer.

4. The vehicle cord organizer of claim 3 wherein the vehicle cord organizer further comprises an adjustable clip that allows the extension to be moved along the length of the body so that the vehicle cord organizer does not impede the flow of air from the vent to which the vehicle cord organizer is connected, said adjustable clip comprising a track and a base;
said track comprising a front, a back, a length, a left edge and a right edge;
the left edge and the right edge or the track being further comprised of at least one of a raised edge or a plurality of teeth;
the back of the track being attached to the back of the body;
the base comprising a bottom, a top, a left side, a right side, and a release mechanism;
the bottom of the base being positioned so as to be against the front of the track such that the left side of the base parallels the left side of the track and the right side of the base parallels the right side of the track;
the release mechanism comprising a lever, a left edge lock and a right edge lock;
the left edge lock comprising at least one of a plurality of teeth or a friction pad and the right edge lock comprising at least one of a plurality of teeth or a friction pad;
wherein the base operates in such a fashion so that, when the lever is engaged the base is slide-able along the length of the track and when the lever is released the left edge lock presses against the left edge of the track and the right edge lock presses against right edge of the track in order to lock the position of the base in place;
wherein the attached end of the extension is connected to the top of the base and the base attaches the extension to the body of the vehicle cord organizer so that, as the base is moved along the length of the track the position of the extension is adjusted relative to the length of the body.

5. The vehicle cord organizer of claim 1 wherein the vehicle cord organizer further comprises a plurality of usb ports and usb power cord;
The usb power cord comprising a first end that is attached to the body of the vehicle cord organizer and a second end to which is attached a DC connector capable of connecting to the power ports of the vehicle;
each usb port of the plurality of usb ports comprising a receptacle and a cable;
the cable of each usb port of the plurality of usb ports comprising a first end that is attached to the receptacle and a second end that is attached to the second end of the usb power cord; and
electricity is capable of traveling from the power ports of the vehicle, through the DC connector, through the usb power cord, to the cables of the plurality of usb ports, and to the receptacles of the plurality of usb ports in order to supply power to the wires wrapped around the vehicle cord organizer.

6. The vehicle cord organizer of claim 5 wherein the vehicle cord organizer further comprises an adjustable clip that allows the extension to be moved along the length of the body so that the vehicle cord organizer does not impede the flow of air from the vent to which the vehicle cord organizer is connected, said adjustable clip comprising a track and a base;
said track comprising a front, a back, a length, a left edge and a right edge;
the left edge and the right edge or the track being further comprised of at least one of a raised edge or a plurality of teeth;
the back of the track being attached to the back of the body;
the base comprising a bottom, a top, a left side, a right side, and a release mechanism;
the bottom of the base being positioned so as to be against the front of the track such that the left side of the base parallels the left side of the track and the right side of the base parallels the right side of the track;
the release mechanism comprising a lever, a left edge lock and a right edge lock;
the left edge lock comprising at least one of a plurality of teeth or a friction pad and the right edge lock comprising at least one of a plurality of teeth or a friction pad;
wherein the base operates in such a fashion so that, when the lever is engaged the base is slide-able along the length of the track and when the lever is released the left edge lock presses against the left edge of the track and the right edge lock presses against right edge of the track in order to lock the position of the base in place;
wherein the attached end of the extension is connected to the top of the base and the base attaches the extension to the body of the vehicle cord organizer so that, as the base is moved along the length of the track the position of the extension is adjusted relative to the length of the body.

7. The vehicle cord organizer of claim 1 wherein the vehicle cord organizer further comprises a plurality of cord stabilizers, said plurality of cord stabilizers being positioned along the length of the front of the body and extending away from the body to aid in separating one cord that is wrapped around the vehicle cord organizer from another cord that is wrapped around the vehicle cord organizer.

8. The vehicle cord organizer of claim 1 wherein at the bottom of the body of the vehicle cord organizer there is a stabilizer bar that extends left and right of the body.

9. The vehicle cord organizer of claim 8 wherein the vehicle cord organizer further comprises an adjustable clip that allows the extension to be moved along the length of the body so that the vehicle cord organizer does not impede the flow of air from the vent to which the vehicle cord organizer is connected, said adjustable clip comprising a track and a base;
said track comprising a front, a back, a length, a left edge and a right edge;
the left edge and the right edge or the track being further comprised of at least one of a raised edge or a plurality of teeth;
the back of the track being attached to the back of the body;
the base comprising a bottom, a top, a left side, a right side, and a release mechanism;
the bottom of the base being positioned so as to be against the front of the track such that the left side of the base parallels the left side of the track and the right side of the base parallels the right side of the track;
the release mechanism comprising a lever, a left edge lock and a right edge lock;
the left edge lock comprising at least one of a plurality of teeth or a friction pad and the right edge lock comprising at least one of a plurality of teeth or a friction pad;
wherein the base operates in such a fashion so that, when the lever is engaged the base is slide-able along the length of the track and when the lever is released the left edge lock presses against the left edge of the track and the right edge lock presses against right edge of the track in order to lock the position of the base in place;
wherein the attached end of the extension is connected to the top of the base and the base attaches the extension to the body of the vehicle cord organizer so that, as the base is moved along the length of the track the position of the extension is adjusted relative to the length of the body.

10. The vehicle cord organizer of claim 9 wherein the vehicle cord organizer further comprises a plurality of cord stabilizers, said plurality of cord stabilizers being positioned along the length of the front of the body and extending away from the body to aid in separating one cord that is wrapped around the vehicle cord organizer from another cord that is wrapped around the vehicle cord organizer.

11. The vehicle cord organizer of claim 10 wherein the vehicle cord organizer further comprises a plurality of usb ports and usb power cord;
The usb power cord comprising a first end that is attached to the body of the vehicle cord organizer and a second end to which is attached a DC connector capable of connecting to the power ports of the vehicle;
each usb port of the plurality of usb ports comprising a receptacle and a cable;
the cable of each usb port of the plurality of usb ports comprising a first end that is attached to the receptacle and a second end that is attached to the second end of the usb power cord; and
electricity is capable of traveling from the power ports of the vehicle, through the DC connector, through the usb power cord, to the cables of the plurality of usb ports, and to the receptacles of the plurality of usb ports in order to supply power to the wires wrapped around the vehicle cord organizer.

12. The vehicle cord organizer of claim 1 wherein the vehicle cord organizer is further comprised of at least one of a rubber coating to increase the friction between the wires wrapped around the vehicle cord organizer and the vehicle cord organizer and/or no-slip edges such that the body of the vehicle cord organizer and each arm of the plurality of arms further comprise edges and those edges are no-slip edges.

13. The vehicle cord organizer of claim 12 wherein the vehicle cord organizer further comprises an adjustable clip that allows the extension to be moved along the length of the body so that the vehicle cord organizer does not impede the flow of air from the vent to which the vehicle cord organizer is connected, said adjustable clip comprising a track and a base;
said track comprising a front, a back, a length, a left edge and a right edge;
the left edge and the right edge or the track being further comprised of at least one of a raised edge or a plurality of teeth;
the back of the track being attached to the back of the body;
the base comprising a bottom, a top, a left side, a right side, and a release mechanism;
the bottom of the base being positioned so as to be against the front of the track such that the left side of the base parallels the left side of the track and the right side of the base parallels the right side of the track;
the release mechanism comprising a lever, a left edge lock and a right edge lock;
the left edge lock comprising at least one of a plurality of teeth or a friction pad and the right edge lock comprising at least one of a plurality of teeth or a friction pad;
wherein the base operates in such a fashion so that, when the lever is engaged the base is slide-able along the length of the track and when the lever is released the left edge lock presses against the left edge of the track and the right edge lock presses against right edge of the track in order to lock the position of the base in place;
wherein the attached end of the extension is connected to the top of the base and the base attaches the extension to the body of the vehicle cord organizer so that, as the base is moved along the length of the track the position of the extension is adjusted relative to the length of the body.

14. The vehicle cord organizer of claim 13 wherein the vehicle cord organizer further comprises a plurality of cord stabilizers, said plurality of cord stabilizers being positioned along the length of the front of the body and extending away from the body to aid in separating one cord that is wrapped around the vehicle cord organizer from another cord that is wrapped around the vehicle cord organizer.

15. The vehicle cord organizer of claim 14 wherein the vehicle cord organizer further comprises a plurality of usb ports and usb power cord;
The usb power cord comprising a first end that is attached to the body of the vehicle cord organizer and a second end to which is attached a DC connector capable of connecting to the power ports of the vehicle;
each usb port of the plurality of usb ports comprising a receptacle and a cable;
the cable of each usb port of the plurality of usb ports comprising a first end that is attached to the receptacle and a second end that is attached to the second end of the usb power cord; and
electricity is capable of traveling from the power ports of the vehicle, through the DC connector, through the usb power cord, to the cables of the plurality of usb ports, and to the receptacles of the plurality of usb ports in order to supply power to the wires wrapped around the vehicle cord organizer.

16. The vehicle cord organizer of claim 15 wherein at the bottom of the body of the vehicle cord organizer there is a stabilizer bar that extends left and right of the body.

17. The vehicle cord organizer of claim 14 wherein the vehicle cord organizer further comprises a plurality of usb ports and usb power cord;
The usb power cord comprising a first end that is attached to the body of the vehicle cord organizer and a second end to which is attached a DC connector capable of connecting to the power ports of the vehicle;
each usb port of the plurality of usb ports comprising a receptacle and a cable;
the cable of each usb port of the plurality of usb ports comprising a first end that is attached to the receptacle and a second end that is attached to the second end of the usb power cord; and
electricity is capable of traveling from the power ports of the vehicle, through the DC connector, through the usb power cord, to the cables of the plurality of usb ports, and to the receptacles of the plurality of usb ports in order to supply power to the wires wrapped around the vehicle cord organizer.

18. The vehicle cord organizer of claim 17 wherein at the bottom of the body of the vehicle cord organizer there is a stabilizer bar that extends left and right of the body.

19. The vehicle cord organizer of claim 18 wherein the vehicle cord organizer is further comprised of at least one of a rubber coating to increase the friction between the wires wrapped around the vehicle cord organizer and the vehicle cord organizer and/or no-slip edges such that the body of the vehicle cord organizer and each arm of the plurality of arms further comprise edges and those edges are no-slip edges.

20. The vehicle cord organizer of claim 3 wherein at the bottom of the body of the vehicle cord organizer there is a stabilizer bar that extends left and right of the body.

21. The vehicle cord organizer of claim 20 wherein the vehicle cord organizer is further comprised of at least one of a rubber coating to increase the friction between the wires wrapped around the vehicle cord organizer and the vehicle cord organizer and/or no-slip edges such that the body of the vehicle cord organizer and each arm of the plurality of arms further comprise edges and those edges are no-slip edges.

22. The vehicle cord organizer of claim 3 wherein the vehicle cord organizer is further comprised of at least one of a rubber coating to increase the friction between the wires wrapped around the vehicle cord organizer and the vehicle cord organizer and/or no-slip edges such that the body of the vehicle cord organizer and each arm of the plurality of arms further comprise edges and those edges are no-slip edges.

23. The vehicle cord organizer of claim 5 wherein at the bottom of the body of the vehicle cord organizer there is a stabilizer bar that extends left and right of the body.

24. The vehicle cord organizer of claim 23 wherein the vehicle cord organizer is further comprised of at least one of a rubber coating to increase the friction between the wires wrapped around the vehicle cord organizer and the vehicle cord organizer and/or no-slip edges such that the body of the vehicle cord organizer and each arm of the plurality of arms further comprise edges and those edges are no-slip edges.

25. The vehicle cord organizer of claim 5 wherein the vehicle cord organizer is further comprised of at least one of a rubber coating to increase the friction between the wires wrapped around the vehicle cord organizer and the vehicle cord organizer and/or no-slip edges such that the body of the vehicle cord organizer and each arm of the plurality of arms further comprise edges and those edges are no-slip edges.

26. The vehicle cord organizer of claim 8 wherein the vehicle cord organizer is further comprised of at least one of a rubber coating to increase the friction between the wires wrapped around the vehicle cord organizer and the vehicle cord organizer and/or no-slip edges such that the body of the vehicle cord organizer and each arm of the plurality of arms further comprise edges and those edges are no-slip edges.
